(19) United States
(12) Patent Application Publication
(10) Pub. No.: US 2024/0290209 A1
(43) Pub. Date: Aug. 29, 2024

(54) SYSTEM FOR AN INTEGRATED FLIGHT DECK SUITE

(71) Applicant: HONEYWELL INTERNATIONAL INC., Charlotte, NC (US)

(72) Inventors: Kalimulla Khan, Bangalore (IN); Kirupakar J, Madurai (IN); Ramkumar Rajendran, Madurai (IN); Philip Toews, Phoenix, AZ (US); Ryan Weeks, Phoenix, AZ (US)

(73) Assignee: HONEYWELL INTERNATIONAL INC., Charlotte, NC (US)

(21) Appl. No.: 18/298,868

(22) Filed: Apr. 11, 2023

(30) Foreign Application Priority Data
Feb. 24, 2023 (IN) 202311012682

(51) Int. Cl. G08G 5/00; B64D 43/00

(52) U.S. Cl. CPC G08G 5/0021; B64D 43/00

(57) ABSTRACT

Systems are provided for a system of an integrated suite of software applications platform for an aircraft. An applications layer of operational applications for a user that includes a safety application kit provides information about diversions, weather avoidance, and standard operating procedures (SOP) for the aircraft, an efficiency application kit that provides information about short-cuts to a flight plan, flight level advisories, and cost index advisories for the aircraft, an automation application kit that provides information about flight logs, technical logs, checklists, flight planning and flight summary for the aircraft, and a dispatcher application kit that provides information about re-routing advisories, wind status, flight dispatch and following traffic status for the aircraft. The system has a data access layer that provides access to relevant databases in support of the applications layer. The system has a platform services layer that provides analytical and security support for the applications platform.

### CROSS-REFERENCE TO RELATED APPLICATION

This application claims priority to India Provisional Patent Application No. 202311012682, filed Feb. 24, 2023, the entire content of which is incorporated by reference herein.

### TECHNICAL FIELD

The present invention generally relates to aircraft instrumentation, and more particularly relates to a system for an integrated flight deck suite.

### BACKGROUND

Aircraft pilots use a wide variety of online applications or a flight planning service for their flight planning needs (e.g., creation, filing, dispatch, clearance). Additionally, pilots are confronted with multiple scenarios during the flight where decisions are required to be made either to avert an abnormal situation, utilize fuel saving opportunities or manage other constraints (e.g., weather, temporary restrictions.) in an optimum manner. Finally, pilots are required to document the flight operations for safety and regulatory mandates including the pilot logs, technical logs, oceanic logs, etc. Hence, there is a need for a system for an integrated flight deck suite for these tasks.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for an integrated suite of software applications platform for an aircraft. The system comprises: an applications layer of operational applications for a user, comprising, a safety application kit that provides information about diversions, weather avoidance, and standard operating procedures (SOP) for the aircraft, an efficiency application kit that provides information about short-cuts to a flight plan, flight level advisories, and cost index advisories for the aircraft, an automation application kit that provides information about flight logs, technical logs, checklists, flight planning and flight summary for the aircraft, and a dispatcher application kit that provides information about re-routing advisories, wind status, flight dispatch and following traffic status for the aircraft; a data access layer that provides access to relevant databases in support of the applications layer; and a platform services layer that provides analytical and security support for the applications platform.

A method is provided for utilizing an integrated suite of software applications platform for an aircraft. The method comprises: accessing an applications layer of operational applications for a user, comprising, a safety application kit that provides information about diversions, weather avoidance, and standard operating procedures (SOP) for the aircraft, an efficiency application kit that provides information about short-cuts to a flight plan, flight level advisories, and cost index advisories for the aircraft, an automation application kit that provides information about flight logs, technical logs, checklists, flight planning and flight summary for the aircraft, and a dispatcher application kit that provides information about re-routing advisories, wind status, flight dispatch and following traffic status for the aircraft; accessing a data access layer that provides access to relevant databases in support of the applications layer; and accessing a platform services layer that provides analytical and security support for the applications platform.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a block diagram of a vehicle system which includes a display system in accordance with one embodiment;

FIG. 2 shows a block diagram of a system of an integrated suite of software applications platform for an aircraft in accordance with one embodiment;

FIG. 3 shows a layout diagram of a display area and panel area in accordance with one embodiment

FIG. 4 shows a diagram of tile overlays for different features of the system in accordance with one embodiment

FIG. 5 shows a layout diagram of a display area and tile overlay in accordance with one embodiment; and

FIG. 6 shows a flowchart for a method for utilizing an integrated suite of software applications platform for an aircraft in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. The provided system and method may be separate from, or integrated within, a preexisting mobile platform management system, avionics system, or aircraft flight management system (FMS).

Systems and methods have been developed for an integrated suite of software applications platform for an aircraft. The system comprises an applications layer of operational applications for a user that includes a safety application kit that provides information about diversions, weather avoidance, and standard operating procedures (SOP) for the aircraft, an efficiency application kit that provides information about short-cuts to a flight plan, flight level advisories, and cost index advisories for the aircraft, an automation application kit that provides information about flight logs, technical logs, checklists, flight planning and flight summary for the aircraft, and a dispatcher application kit that provides information about re-routing advisories, wind status, flight dispatch and following traffic status for the aircraft. The system has a data access layer that provides access to relevant databases in support of the applications layer. The system has a platform services layer that provides analytical and security support for the applications platform.

Pilots typically use online applications or other flight planning services for their flight planning tasks such as creation and filing of plans, dispatch, clearance, etc. These applications assist in decisions to avert an abnormal situation, utilize fuel saving opportunities, manage weather, temporary restrictions, etc. in an optimum manner. Pilots are also required to document the flight operations for safety and operational history including a pilot log, technical log, oceanic logs, etc. It is advantageous to use a unitary platform or a “Single Pane of Glass” (SPOG) interface where all of these activities can be performed in a seamless and reliable manner over a suite of inflight advisory operations around safety, efficiency, automation, and dispatch-related flight management system (FMS) uses.

An “integrated flight deck” (IFD) is a suite of applications that aid with flight planning, real-time decision making and routine book-keeping activities for a flight. It provides an intuitive single pane of glass interface, which is a user-friendly way to use these applications hosted on touch-enabled devices (e.g., iPads) that may be carried onto an aircraft by a pilot. An IFD enables ease of use of the applications and switching between applications while ensuring basic operations are easily performed in all environments.

Additionally, application development for products targeted to interface with avionics systems may have a multidimensional problems. Security requirements, interfacing with avionics devices and cloud-based services, subscription and licensing details must be integrated into the platform. Developers need access to all the required software development kits (SDK) and properly integrate them into their application. Present embodiments provide a guided development platform that hides all this complexity from the user and aggregates the avionics-provided data to allow multisystem applications to easily communicate with the entire avionics suite. This provides an easy-to-use format that enables developers to quickly develop mobile avionics applications without becoming domain experts in all the various avionics systems or cloud-based services with which their application will interface.

There are several primary advantages of an IFD. It provides a framework that provides an SDK to build new applications or “apps” without starting from scratch. For example, if a connected auxiliary power unit (APU) wants to provide an electronic flight bag (EFB) application, there is typically high development cost involved. In addition, the user may not have the expertise to develop an app. A centralized app like the IFD will allow for reduced development costs and also hosting features on the app. Additionally, the IFD provides an umbrella app enables the purchase and use of additional hosted apps as they become available. This includes a simplified way to buy upgrades, do trial runs of host applications, etc.

Additionally, the IFD consolidates avionics SDKs into a framework that easily enables rapid prototyping and deployment of proof-of-concept apps/features. For example, a user can have an idea, cover 80% of what is needed with what is already available within the framework, and use existing sets of widgets to build the rest.

Also, the IFD incorporates existing content with an appropriate mix of reuse vs. new development. If a large amount of content has been produced, that makes sense to include the existing material in the framework, but not at the expense of complexity and ease of use. Tradeoffs will be required to determine the appropriate mix of reuse vs new development.

To choose a correct mix of native vs external content, it is understood that native content usually has lower risk but also lower portability, so looking toward a multiple platform future, it is desirable to minimize the amount of content that would need to be duplicated for each platform. A framework with a common look and feel, common behavior provides simplified user experience across the suite of hosted applications. The user interface (UI) content should be configurable to be changed from one user to another without impacting the application logic.

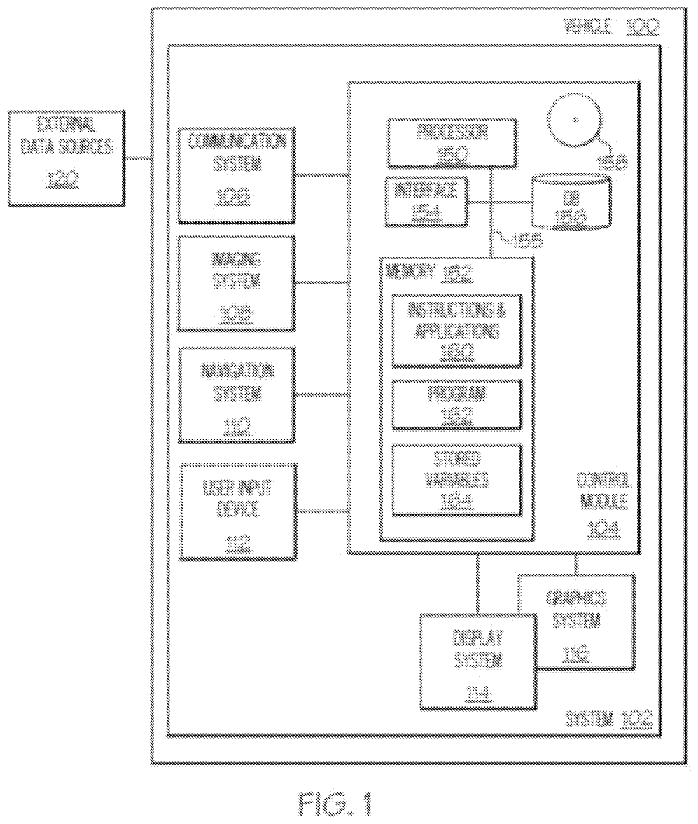

Turning now to FIG. 1, in the depicted embodiment, the vehicle system 102 includes: the control module 104 that is operationally coupled to a communication system 106, an imaging system 108, a navigation system 110, a user input device 112, a display system 114, and a graphics system 116. The operation of these functional blocks is described in more detail below. In the described embodiments, the depicted vehicle system 102 is generally realized as an aircraft flight deck display system within a vehicle 100 that is an aircraft; however, the concepts presented here can be deployed in a variety of mobile platforms, such as land vehicles, spacecraft, watercraft, and the like. Accordingly, in various embodiments, the vehicle system 102 may be associated with or form part of larger aircraft management system, such as a flight management system (FMS).

In the illustrated embodiment, the control module 104 is coupled to the communications system 106, which is configured to support communications between external data source(s) 120 and the aircraft. External source(s) 120 may comprise air traffic control (ATC), or other suitable command centers and ground locations. Data received from the external source(s) 120 includes the instantaneous, or current, visibility report associated with a target landing location or identified runway. In this regard, the communications system 106 may be realized using a radio communication system or another suitable data link system.

The imaging system 108 is configured to use sensing devices to generate video or still images, and provide image data therefrom. The imaging system 108 may comprise one or more sensing devices, such as cameras, each with an associated sensing method. Accordingly, the video or still images generated by the imaging system 108 may be referred to herein as generated images, sensor images, or sensed images, and the image data may be referred to as sensed data. In an embodiment, the imaging system 108 comprises an infrared (“IR”) based video camera, low-light TV camera, or a millimeter wave (MMW) video camera. The IR camera senses infrared radiation to create an image in a manner that is similar to an optical camera sensing visible light to create an image. In another embodiment, the imaging system 108 comprises a radar based video camera system. Radar based systems emit pulses of electromagnetic radiation and listen for, or sense, associated return echoes. The radar system may generate an image or video based upon the sensed echoes. In another embodiment, the imaging system 108 may comprise a sonar system. The imaging system 108 uses methods other than visible light to generate images, and the sensing devices within the imaging system 108 are much more sensitive than a human eye. Consequently, the generated images may comprise objects, such as mountains, buildings, or ground objects, that a pilot might not otherwise see due to low visibility conditions.

In various embodiments, the imaging system 108 may be mounted in or near the nose of the aircraft (vehicle 100) and calibrated to align an imaging region with a viewing region of a primary flight display (PFD) or a Head Up display (HUD) rendered on the display system 114. For example, the imaging system 108 may be configured so that a geometric center of its field of view (FOV) is aligned with or otherwise corresponds to the geometric center of the viewing region on the display system 114. In this regard, the imaging system 108 may be oriented or otherwise directed substantially parallel to an anticipated line-of-sight for a pilot and/or crew member in the cockpit of the aircraft to effectively capture a forward looking cockpit view in the respective displayed image. In some embodiments, the displayed images on the display system 114 are three dimensional, and the imaging system 108 generates a synthetic perspective view of terrain in front of the aircraft. The synthetic perspective view of terrain in front of the aircraft is generated to match the direct out-the-window view of a crew member, and may be based on the current position, attitude, and pointing information received from a navigation system 110, or other aircraft and/or flight management systems.

Navigation system 110 is configured to provide real-time navigational data and/or information regarding operation of the aircraft. The navigation system 110 may be realized as a global positioning system (GPS), inertial reference system (IRS), or a radio-based navigation system (e.g., VHF omni-directional radio range (VOR) or long range aid to navigation (LORAN)), and may include one or more navigational radios or other sensors suitably configured to support operation of the navigation system 110, as will be appreciated in the art. The navigation system 110 is capable of obtaining and/or determining the current or instantaneous position and location information of the aircraft (e.g., the current latitude and longitude) and the current altitude or above ground level for the aircraft. Additionally, in an exemplary embodiment, the navigation system 110 includes inertial reference sensors capable of obtaining or otherwise determining the attitude or orientation (e.g., the pitch, roll, and yaw, heading) of the aircraft relative to earth.

The user input device 112 is coupled to the control module 104, and the user input device 112 and the control module 104 are cooperatively configured to allow a user (e.g., a pilot, co-pilot, or crew member) to interact with the display system 114 and/or other elements of the vehicle system 102 in a conventional manner. The user input device 112 may include any one, or combination, of various known user input device devices including, but not limited to: a touch sensitive screen; a cursor control device (CCD) (not shown), such as a mouse, a trackball, or joystick; a keyboard; one or more buttons, switches, or knobs; a voice input system; and a gesture recognition system. In embodiments using a touch sensitive screen, the user input device 112 may be integrated with a display device. Non-limiting examples of uses for the user input device 112 include: entering values for stored variables 164, loading or updating instructions and applications 160, and loading and updating the contents of the database 156, each described in more detail below.

The generated images from the imaging system 108 are provided to the control module 104 in the form of image data. The control module 104 is configured to receive the image data and convert and render the image data into display commands that command and control the renderings of the display system 114. This conversion and rendering may be performed, at least in part, by the graphics system 116. In some embodiments, the graphics system 116 may be integrated within the control module 104; in other embodiments, the graphics system 116 may be integrated within the display system 114. Regardless of the state of integration of these subsystems, responsive to receiving display commands from the control module 104, the display system 114 displays, renders, or otherwise conveys one or more graphical representations or displayed images based on the image data (i.e., sensor based images) and associated with operation of the vehicle 100, as described in greater detail below. In various embodiments, images displayed on the display system 114 may also be responsive to processed user input that was received via a user input device 112.

In general, the display system 114 may include any device or apparatus suitable for displaying flight information or other data associated with operation of the aircraft in a format viewable by a user. Display methods include various types of computer generated symbols, text, and graphic information representing, for example, pitch, heading, flight path, airspeed, altitude, runway information, waypoints, targets, obstacle, terrain, and required navigation performance (RNP) data in an integrated, multi-color or monochrome form. In practice, the display system 114 may be part of, or include, a primary flight display (PFD) system, a panel-mounted head down display (HDD), a head up display (HUD), or a head mounted display system, such as a “near to eye display” system. The display system 114 may comprise display devices that provide three dimensional or two dimensional images, and may provide synthetic vision imaging. Non-limiting examples of such display devices include cathode ray tube (CRT) displays, and flat panel displays such as LCD (liquid crystal displays) and TFT (thin film transistor) displays. Accordingly, each display device responds to a communication protocol that is either two-dimensional or three, and may support the overlay of text, alphanumeric information, or visual symbology.

As mentioned, the control module 104 performs the functions of the vehicle system 102. With continued reference to FIG. 1, within the control module 104, the processor 150 and the memory 152 (having therein the program 162) form a novel processing engine that performs the described processing activities in accordance with the program 162, as is described in more detail below. The control module 104 generates display signals that command and control the display system 114.

The control module 104 includes an interface 154, communicatively coupled to the processor 150 and memory 152 (via a bus 155), database 156, and an optional storage disk 158. In various embodiments, the control module 104 performs actions and other functions in accordance with other embodiments. The processor 150 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals.

The memory 152, the database 156, or a disk 158 maintain data bits and may be utilized by the processor 150 as both storage and a scratch pad. The memory locations where data bits are maintained are physical locations that have particular electrical, magnetic, optical, or organic properties corresponding to the data bits. The memory 152 can be any type of suitable computer readable storage medium. For example, the memory 152 may include various types of dynamic random access memory (DRAM) such as SDRAM, the various types of static RAM (SRAM), and the various types of non-volatile memory (PROM, EPROM, and flash). In certain examples, the memory 152 is located on and/or co-located on the same computer chip as the processor 150. In the depicted embodiment, the memory 152 stores the above-referenced instructions and applications 160 along with one or more configurable variables in stored variables 164. The database 156 and the disk 158 are computer readable storage media in the form of any suitable type of storage apparatus, including direct access storage devices such as hard disk drives, flash systems, floppy disk drives and optical disk drives. The database may include an airport database (comprising airport features) and a terrain database (comprising terrain features). In combination, the features from the airport database and the terrain database are referred to map features. Information in the database 156 may be organized and/or imported from an external source 120 during an initialization step of a process.

The bus 155 serves to transmit programs, data, status and other information or signals between the various components of the control module 104. The bus 155 can be any suitable physical or logical means of connecting computer systems and components. This includes, but is not limited to, direct hard-wired connections, fiber optics, infrared and wireless bus technologies.

The interface 154 enables communications within the control module 104, can include one or more network interfaces to communicate with other systems or components, and can be implemented using any suitable method and apparatus. For example, the interface 154 enables communication from a system driver and/or another computer system. In one embodiment, the interface 154 obtains data from external data source(s) 120 directly. The interface 154 may also include one or more network interfaces to communicate with technicians, and/or one or more storage interfaces to connect to storage apparatuses, such as the database 156.

It will be appreciated that the vehicle system 102 may differ from the embodiment depicted in FIG. 1. As mentioned, the vehicle system 102 can be integrated with an existing flight management system (FMS) or aircraft flight deck display.

During operation, the processor 150 loads and executes one or more programs, algorithms and rules embodied as instructions and applications 160 contained within the memory 152 and, as such, controls the general operation of the control module 104 as well as the vehicle system 102. In executing the process described herein, the processor 150 specifically loads and executes the novel program 162. Additionally, the processor 150 is configured to process received inputs (any combination of input from the communication system 106, the imaging system 108, the navigation system 110, and user input provided via user input device 112), reference the database 156 in accordance with the program 162, and generate display commands that command and control the display system 114 based thereon.

Present embodiment of an IFD provides an integrated platform (app) designed over the SPOG concept for portable electronic devices (e.g., tablets, phones, and laptops) which can be uses to rapidly deploy a wide variety of pre-flight and in-flight uses for the pilots, operators, ground stations, original equipment manufacturers (OEM), and other associated stakeholders. The SPOG concept is an integrated application suite in which it will provide a singular intuitive user interface to cater multitude of avionics use cases around safety, efficiency, automation, and dispatch. The IFD provide tools that harness the real-time information around us to make flight operations casier, safer and more efficient. The system also allows for regular updates and rapid deployment of new features without historical certification costs and time.

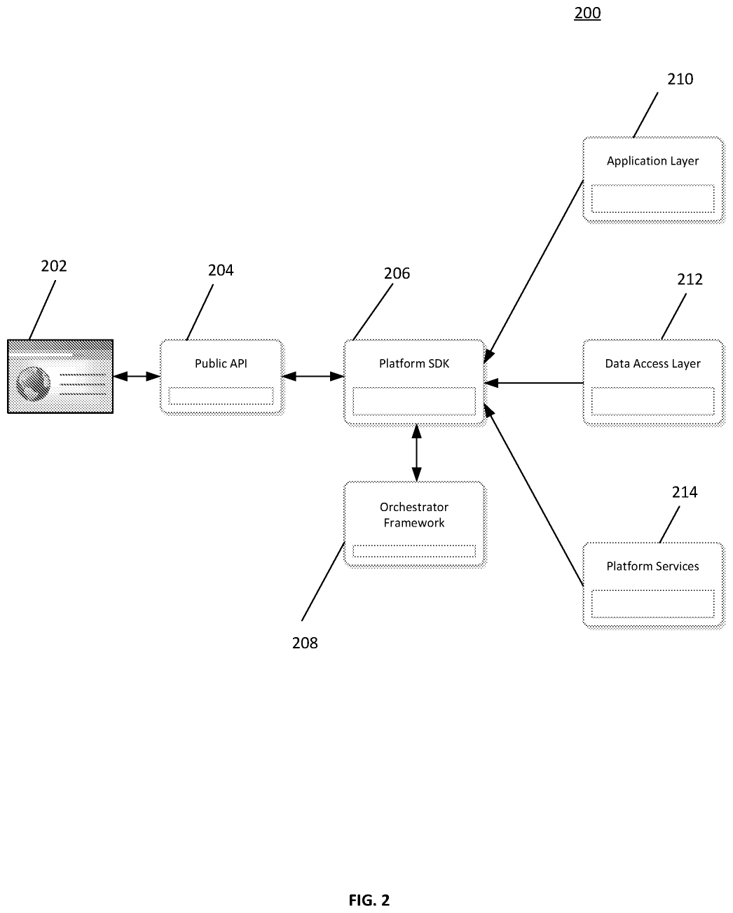

Turning now to FIG. 2, a block diagram 200 is shown of a system of an IFD suite of software applications platform for an aircraft in accordance with one embodiment. It should be understood that the source of data, the engines for computation, the connectivity infrastructure, etc. depicted in the diagram can be changed based on user needs for reliability, cost, or restrictions without impacting the overall use. A SPOG Integrated user interface (UI) 202 is the integrated suite in which the pilot will be able to access or navigate along the features across multiple domain applications around flight efficiency, flight safety, and pilot automation or dispatcher routines. The Public API 204 is the public-facing API that will be exposed to the third-party applications or user interface components which will be receiving inputs from the data access layer or application layers.

The IFD Platform SDK 206 is the core SDK that will aggregate the collection of framework components, data SDKs, application engines, UI libraries, rules which specify how applications be developed from the platform and how additional SDKs and libraries can be added to the platform. This layer will implement an extensible object model using an application framework towards externalizing the multitude and complex avionics sub-system real-time data. Multiple features related to flight efficiency and safety can be built using a “Plug & Play” concept along with the extensible object model across multitude of avionics domain systems. This is done without requiring understanding of the low-level intricacies. Application developers are provided with easy-to-use abstracted access to the core features without intimated domain knowledge of the used resources.

The Orchestrator Framework 208 is a collection of framework components, SDKs, UI libraries and rules which specify how applications can be developed from the platform and how additional SDKs and Libraries can be added to the platform. The framework contains abstraction between the SDKs and the applications. It enforces a standard interface that all SDKs must utilize. It creates the concrete instances for the SDKs, manages the number of objects created as well as the lifespan of the objects. This is accomplished via the data abstraction as specified via the architecture as well as the inclusion of the necessary SDKs within the platform.

The Application Layer 210 is a layer of application-related SDKs including: a safety SDK; an efficiency SDK; an automation SDK; a dispatcher SDK. The safety SDK provides energy management, emergency diversion, last moment change, weather hazard avoidance and SOP advisories. The efficiency SDK provides short-cut advisor, flight level advisor, cost index advisor and micro shortcuts. The automation SDK provides oceanic flight logs, checklist, tech log/flight log, flight summary, and multi-leg flight planning. The dispatcher SDK provides re-routing advisories, wind uplink, flight re-dispatch and flight following.

In one example, a third-party application would be able to build a “Short-cut Advisor” feature by using the APIs provided by the efficiency SDK. The system retrieves shortcut databases, weather and traffic services etc. from external sources. It receives the active flight plan and the aircraft state from the avionics based on configured periodicity and it then applies the business logic for detecting a potential shortcut which is displayed to the crew.

The Data Access Layer 212 is a layer responsible for providing data from various avionics subsystems to third party applications. Some examples of hosted data SDKs in the IFD platform include: hosted SDK for Connected FMS; hosted SDK for Weather Radar; hosted SDK for Connected Global Positioning System (GPS); hosted SDK for Engine; hosted SDK for APU; hosted SDK that will contain FME and TOLDE engines and connection management to ADAP; hosted SDK containing connection management to the cloud; hosted SDK containing logon and security components; security interface with avionics cloud services; and bi-directional communication with onboard avionics systems such as FMS, radar, engine, APU, wheels and brakes. The Platform Services 214 provides an analytics SDK, a license manager, business support services, a secure enclave and UI Widgets.

An “engine” is defined as a self-contained piece of business functionality with clear interfaces that are contained within a hosted SDK. Some examples of engines for FMS would be the Flight Management Engine (FME), Takeoff and Landing Engine (TOLDE), a Navigation Database Engine, as well as higher-order content as a flight plan comparator utility. A “feature” is a simple entity that can be used by the pilot to achieve end-to-end functionality. This will be the combination of SPOG UI Widget, data access layer object, and application layer objects.

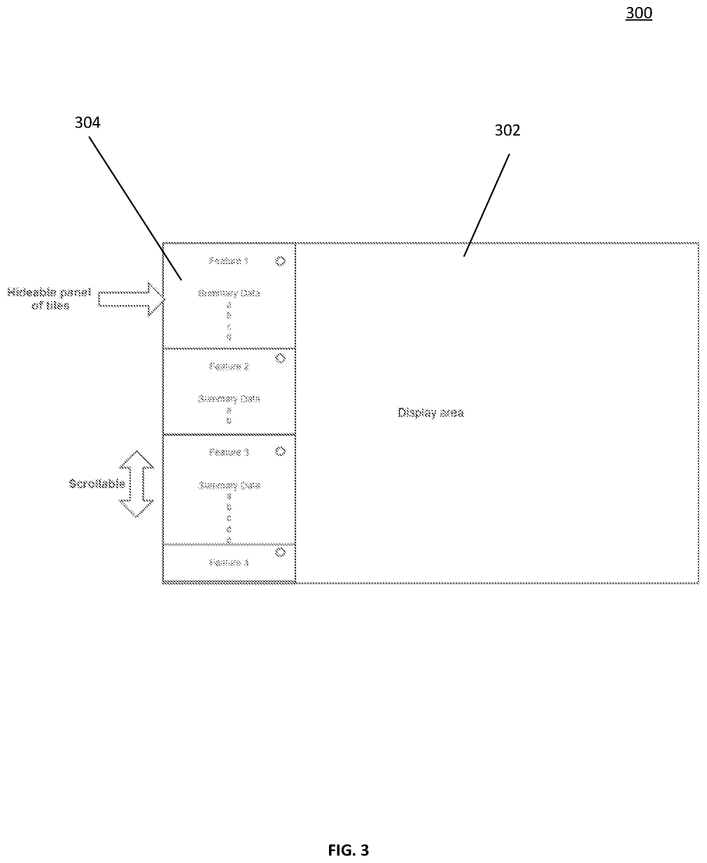

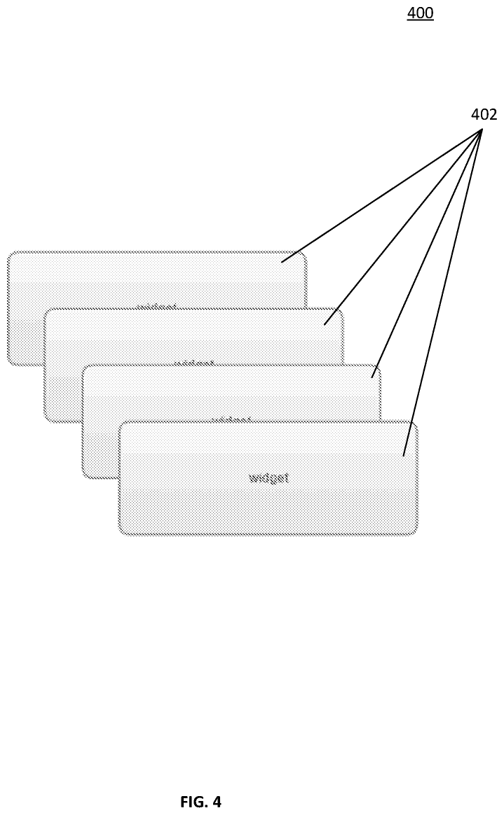

FIG. 3 shows a layout diagram 300 of a display area 302 and panel area 304 in accordance with one embodiment. The left side of the display contains a hide-able panel 304 that contains tiles for the available features. The tiles can be scrolled up and down within this panel if there are more tiles selected than can be displayed at any one time. Each tile may contain a notification (which may be used to indicate the feature has critical data to be acted upon) and/or summary data. The tiles may vary in size depending upon the amount of data to be displayed. FIG. 4 shows a diagram 400 of tile overlays 402 for different features of the system in accordance with one embodiment. A user may manually order tiles 402, and/or the tiles may be ordered by priority. The contents of the display area 302 of FIG. 3 are determined by tile selection in the left panel 304. When a tile 402 is selected, the feature corresponding to the tile takes over the display area 302 and uses it for interaction display and entry of data.

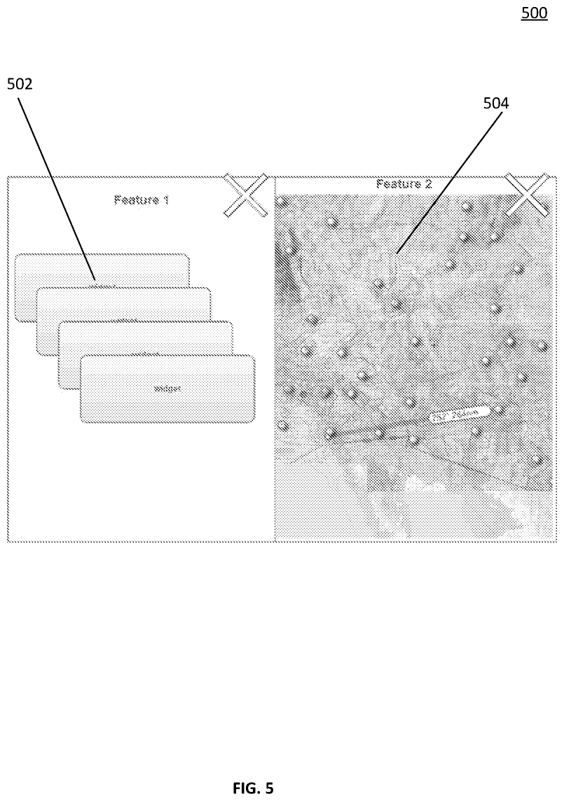

FIG. 5 shows a layout diagram 500 of a display area 504 and tile overlay 502 in accordance with one embodiment. If more than one tile 502 is selected, the display area 504 can be divided horizontally or vertically as needed. When the display area 504 is divided between multiple features, the top right of each feature's display is reserved for an icon which can be used to close that portion of the display area. Upon closing a portion of the divided display, the display 504 reverts back to being fulling displayed by a single feature as in FIG. 3.

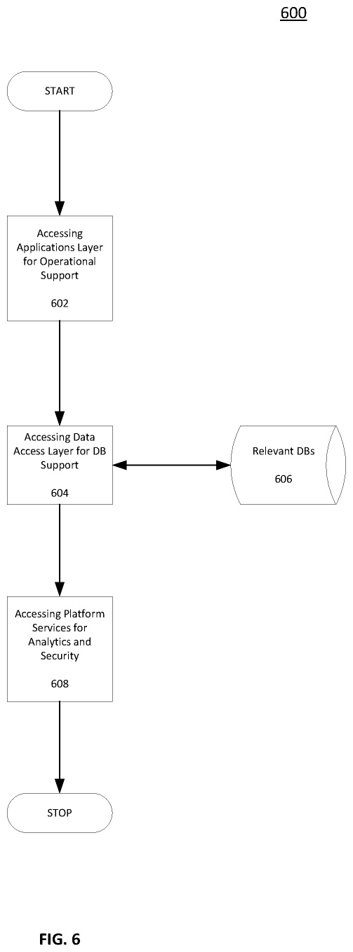

FIG. 6 shows a flowchart 600 for a method for utilizing an integrated suite of software applications platform for an aircraft in accordance with one embodiment. The method includes accessing an applications layer of operational applications for a user 602. The application layer includes: a safety application SDK that provides information about diversions, weather avoidance, and standard operating procedures (SOP) for the aircraft; an efficiency SDK that provides information about short-cuts to a flight plan, flight level advisories, and cost index advisories for the aircraft; an automation application SDK that provides information about flight logs, technical logs, checklists, flight planning and flight summary for the aircraft, and a dispatcher application SDK that provides information about re-routing advisories, wind status, flight dispatch and following traffic status for the aircraft. Next, a data access layer is accessed 604 that provides access to relevant databases 606 in support of the applications layer. Finally, a platform services layer is accessed 608 that provides analytical and security support for the applications platform.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system of an integrated suite of software applications platform for an aircraft, comprising:
an applications layer of operational applications for a user, comprising,
a safety application kit that provides information about diversions, weather avoidance, and standard operating procedures (SOP) for the aircraft,
an efficiency application kit that provides information about short-cuts to a flight plan, flight level advisories, and cost index advisories for the aircraft,
an automation application kit that provides information about flight logs, technical logs, checklists, flight planning and flight summary for the aircraft, and
a dispatcher application kit that provides information about re-routing advisories, wind status, flight dispatch and following traffic status for the aircraft;
a data access layer that provides access to relevant databases in support of the applications layer; and
a platform services layer that provides analytical and security support for the applications platform.

2. The system of claim 1, where the applications platform further comprises:
a unitary display that shows the displays of each application kit of the applications layer in accordance with user selections.

3. The system of claim 2, where the unitary display comprises and electronic flight bag (EFB).

4. The system of claim 2, where unitary display comprises a personal electronic device.

5. The system of claim 4, where the personal electronic display comprises a smartphone.

6. The system of claim 4, where the personal electronic display comprises a laptop computer.

7. The system of claim 4, where the personal electronic display comprises a tablet.

8. The system of claim 1, where the data access layer provides bidirectional data communications with onboard avionics systems of the aircraft.

9. The system of claim 8, where the onboard avionics systems comprise a flight management system (FMS).

10. The system of claim 8, where the onboard avionics systems comprise a radar system.

11. The system of claim 8, where the onboard avionics systems comprise an aircraft engine.

12. The system of claim 8, where the onboard avionics systems comprise an auxiliary power unit (APU).

13. The system of claim 8, where the onboard avionics systems comprise aircraft wheels.

14. The system of claim 8, where the onboard avionics systems comprise aircraft brakes.

15. The system of claim 8, where the onboard avionics systems comprise a global positioning system (GPS).

16. The system of claim 1, where the platform services layer provides data application analytic functions.

17. The system of claim 1, where the platform services layer provides application license management.

18. The system of claim 1, where the platform services layer provides application access management.

19. The system of claim 1, where the platform services layer provides application business support services.

20. A method for utilizing an integrated suite of software applications platform for an aircraft, comprising:
accessing an applications layer of operational applications for a user, comprising,
a safety application kit that provides information about diversions, weather avoidance, and standard operating procedures (SOP) for the aircraft,
an efficiency application kit that provides information about short-cuts to a flight plan, flight level advisories, and cost index advisories for the aircraft,
an automation application kit that provides information about flight logs, technical logs, checklists, flight planning and flight summary for the aircraft, and
a dispatcher application kit that provides information about re-routing advisories, wind status, flight dispatch and following traffic status for the aircraft;
accessing a data access layer that provides access to relevant databases in support of the applications layer; and
accessing a platform services layer that provides analytical and security support for the applications platform.
